(19) United States
(12) Patent Application Publication
(10) Pub. No.: US 2019/0066231 A1
(43) Pub. Date: Feb. 28, 2019

(54) METHODS AND SYSTEMS FOR PROVIDING CONTENT TO A USER OF A RELATIONSHIP NETWORK

(71) Applicant: Deskera Singapore Pte Ltd, Singapore (SG)

(72) Inventors: Shashank DIXIT, Singapore (SG); Somesh MISRA, Singapore (SG)

(73) Assignee: Deskera Singapore Pte Ltd, Singapore (SG)

(21) Appl. No.: 15/774,285

(22) PCT Filed: Nov. 9, 2016
(86) PCT No.: PCT/SG2016/050555

§ 371 Date: May 8, 2018

(30) Foreign Application Priority Data
Nov. 9, 2015 (SG) 10201509267W
Nov. 9, 2015 (SG) 10201509269P
Nov. 9, 2015 (SG) 10201509270S

(51) Int. Cl. G06Q 50/00; G06N 7/00

(52) U.S. Cl. CPC G06Q 50/01; G06Q 30/0269; G06N 7/005

(57) ABSTRACT

A method of providing content to users of a relationship network is disclosed. The method comprises: receiving an indication of a target content item; analyzing content interaction history data for users of the relationship network to determine a probability metric for a target user of the relationship network, the content interaction history data indicating, for each user of a plurality of users of the relationship network, content items with which that user interacted, the probability metric indicating a probability that the target user will access the target content item; determining if the target user meets a content forwarding criterion, the content forwarding criterion comprising a threshold for the probability metric; and providing the target content item to the target user if the target user meets the content forwarding criterion.

### FIELD OF THE INVENTION

Embodiments of the present invention relate to the general field of internet based transferal of computer readable contents and to the field of relationship network analysis. In particular, embodiments of the present invention concern targeting relevant contents on the internet to send/refer to internet users.

### BACKGROUND OF THE INVENTION

Relationship networking software applications allow users to create a personal and private networking community in which people, known as users, network through associates, associates of associates, and so forth. An associate of a user on a relationship network is another user on the network who is related to the said user, for example a friend on a social network, a business associate such as a vendor, customer, employee of a company and the like. A user begins by creating a personal profile that includes the names of the user's associates. One of the main advantages of such applications is that a user can browse and search through all of the users connected to a user through networks of associates. A user can view photos and profiles, see how the user is connected to other users, send messages, ask associates for introductions, or suggest matches between associates or even associates of associates. Such applications can be used for all types of relationship networking, including making friends, etc. The information mined from the relationship network is of great use in determining key features like the demography, interests, income-group, etc. of the user.

Recently, sharing contents over more interactive media has become popular. A content item is a computer readable object (or a collection of computer readable objects) such as web-pages, images, videos, emails and the like. For example, as the number of people using the Internet has exploded, advertisers have come to appreciate media and services offered over the Internet as a potentially powerful way to advertise. Advertisers such as merchants have developed several strategies in an attempt to maximize the value of such advertising. In one strategy, advertisers use popular presences or means for providing interactive media or services (referred to as “websites” in the specification without loss of generality) as conduits to reach a large audience. Website-based advertisements (also referred to as “web ads”) are typically presented to their advertising audience in the form of “banners”, a rectangular box that may include graphic components. When a member of the target audience (referred to as a “viewer” or “user”) selects one of these contents by clicking on it, embedded hypertext links typically direct the viewer to the merchant's website.

The process, wherein the viewer clicks on a content to open and view the content, is commonly referred to as a “click-through” (in the present disclosure the term “click-through” is intended to cover any type of user selection). Merchants may judge the efficacy of a marketing campaign using a number of measurable or determinable user behaviors, such as click-through, click-through rates, conversions, conversion rates, etc. The ratio of the number of click-through to the number of impressions of the content (i.e., the number of times a content item is sent to users) is commonly referred to as the “click-through rate” of the content. Despite the initial promise of website-based marketing, there remain several problems with existing approaches. Although merchants are able to reach a large audience, they are frequently dissatisfied with the return on their marketing investment.

Existing client-side software systems can show contents within a user's browser or on the user's desktop in response to a Web page being viewed without awareness or participation by the content owner, contents may be targeted to users using (i) demographic and lifestyle profiles, (ii) behavioral targeting (which allows targeted, customize messages to be displayed on users' computer screens based on their individual online behavior), (iii) historical targeting (which allows targeted, customized contents to be displayed on users' computer screens based on past behavior), and (iv) tag-a-long targeting (which allows targeted, customized contents to be displayed on users' computer screens whose online behavior has indicated an interest, but also delivers multiple impressions as they travel around the web).

Unfortunately, although past user behavior is often a useful metric for determining what content(s) to serve to a user, such past behavior might not be strongly indicative of a current user interest. Further, past user behavior for a given user may be difficult to track if more than one person (such as different members of a family) uses the same computer and browser to access the Internet.

None of the existing methods to determine the relevance of content to a user leverage the information available from his/her relationship network. As an example, some existing methods determine relevance of a content with a user using his/her online behavior vis-à-vis the emails he writes, followed by a text search for keywords like “car”, and thereby relating the user to a content related to a car that might not be available in his/her country. This fallacy stems from the fact that complete information about a user is not decipherable from his/her online behavior without considering his/her online environment in the form of his/her relationship network. The present invention easily overcomes this fallacy by mining behavioral information from a user's relationship network.

Thus, there is a need to utilize content sending opportunities on the web more fully and there is a need in the industry for better mechanisms to manage, mine, and cultivate personal networks. Doing so should help the merchant serve more relevant contents and enhance the experience of end users. It is with respect to these considerations and others that the present invention has been made.

### SUMMARY OF THE INVENTION

In general terms, embodiments of the present invention provide methods and systems for providing content items to users of a relationship network. In some embodiments, a content item is provided to a target user if the target user meets a forwarding criterion. The forwarding criterion may be determined from a calculated probability that the user will interact with the content item, for example, clicking on the content item. In some embodiments, the forwarding criterion is additionally or alternatively based on a profile feature of the target user. Some embodiments provide for the estimation of missing profile features of users of a relationship network. Further embodiments provide for the referral of a content item by one user of a relationship network to another user. It is envisaged that these embodiments may be implemented either individually or in combination.

According to a first aspect of the present invention there is provided a method of providing content to users of a relationship network. The method comprising: receiving an indication of a target content item; analyzing content interaction history data for users of the relationship network to determine a probability metric for a target user of the relationship network, the content interaction history data indicating, for each user of a plurality of users of the relationship network, content items with which that user interacted, the probability metric indicating a probability that the target user will access the target content item; determining if the target user meets a content forwarding criterion, the content forwarding criterion comprising a threshold for the probability metric; and providing the target content item to the target user if the target user meets the content forwarding criterion.

Some embodiments of the present invention provide a method to determine the probability of a given user (who is a member of a relationship network) to click on a given content. The probability is calculated using information based on data gathered from the clicking of contents in the past by the members of the relationship network. One strength of such embodiments is the use of the graph topology inherent in the relationship networks.

In an embodiment, analyzing content interaction history for users of the relationship network to determine a probability metric for a target user of the relationship network comprises analyzing the content interaction history of users having a link in the relationship network to the target user.

In an embodiment, analyzing content interaction history for users of the relationship network to determine a probability metric for a target user of the relationship network comprises identifying related content with which the target user interacted; identifying users that interacted with the related content; and identifying which of the users that interacted with the related content also interacted with the target content.

A correlation is sought between the said user and the content using existing correlations: between past contents and the current content, between other users and the current content, between other users and the said user. The correlation procedure determines the relevance of the content to the user and thus determines the said probability.

The content forwarding criterion may further comprise a profile feature or range of values for a profile feature of the target user.

In some embodiments, the method further comprises determining a predicted value for the profile feature of the target user by analyzing relationship data indicating relationships between users of the relationship network and user profile data indicating values of the profile feature for users of the relationship network.

Some embodiments of the present invention provide a method to predict profile features of members of a relationship network. The information provided by the members of a relationship network as part of their online profile is vital for leveraging the use of the relationship network by members. This information or profile features are sometimes not provided by the user or become outdated. The topology of the graph structure of the relationship network is used to mine this information.

The method presented is based on two ideas. First, the given user's profile will be similar to the other users in his/her neighbourhood. Secondly, the users in the neighbourhood of the given user will contribute to its profile in such a way that all users have a predetermined normalized distribution of features in their respective profiles. Individuals with similar profiles will have similar feature-structure and hence will have similar Eigen-analysis coordinates. Therefore in order to predict a particular feature value like age, the average age of linked users will be computed. Additionally, a list of people with similar Eigen-coordinates will be prepared and the average age of the list will be computed. The age of the user in question will depend on both these ages. Finally, the predicted feature values will be adjusted in order to retain the proportion of various possible values before prediction.

The predicted value of the profile feature may be determined by representing the relationship network as a graph having a plurality of nodes, with each node corresponding to a user of the relationship network and the graph having arcs between pairs of nodes corresponding to linked users of the relationship network. Each node may be considered as having a plurality of feature values corresponding to the profile features of the user corresponding to the node and assigning a probability distribution or probability vector to the feature values, the probability distribution or probability vector indicating the probability that the feature values will take a value.

In some embodiments, the method further comprises, after providing the target content to the target users, receiving a referral indication from the target user, the referral indication indicating a user, suggested to receive the target content.

The method may further comprise comparing a referral strength score associated with the target user with a threshold and providing the target content to the suggested user if the referral strength score is greater than the threshold. The referral strength score associated with the target user may be increased if the suggested user interacts with the target content.

Some embodiments of the present invention provide methods and systems which implements content referrals in a computerized relationship network. The desired aim for the system is to encourage relevant content referral and thus provide a targeted content sharing scenario for merchants and at the same time enhance users' experience. The information stored about the referrals of contents to users serves as a very useful and accurate database for determining the relevance of a content item to a user.

The method of determining a profile feature for a user of a relationship network may be implemented independently from the other aspects described above. Thus, according to a second aspect of the second invention there is provided a method of providing content to users of a relationship network. The method comprises: receiving an indication of a target content item; determining a predicted value for a profile feature of the target user by analyzing relationship data indicating relationships between users of the relationship network and user profile data indicating values of the profile feature for users of the relationship network; determining if the target user meets a content forwarding criterion, the content forwarding criterion comprising the profile feature or range of values for the profile feature of the target user; and providing the target content item to the target user if the target user meets the content forwarding criterion.

The referral of content items by a user may also be provided independently from the other aspects. Thus, according to a third aspect of the present invention there is provided a method of providing content to users of a relationship network. The method comprises: providing a target content item to a first user of the relationship network; receiving a referral indication from the first user of the relationship network, the referral indication indicating a second user suggested by the first user to receive the target content item; and providing the target content item to the second user.

According to a fourth aspect of the present invention there is provided a method of providing content to users of a relationship network. The method comprises: providing a target content item to a first user of the relationship network; receiving a referral indication from the first user of the relationship network, the referral indication indicating a second user suggested by the first user to receive the target content item; comparing a referral strength score associated with the first user with a threshold; and providing the target content item to the second user if the referral strength score associated with the first user is greater than the threshold.

According to a further aspect of the present invention there is provided a computer readable medium which carries processor executable instructions which when executed cause the processor to carry out a method described above. The computer readable medium may be a non-transitory computer readable medium such as an optical or magnetic disc, a solid state memory device; a read only memory device; or other known computer readable medium.

According to yet further aspects of the present invention there is provided a third aspect there is provided a data processing system for providing content to users of a relationship network, the system comprising a processor and a data storage device storing processor executable instructions for carrying out one of the methods described above.

In some embodiments of the present invention a web-based method and system for content sharing which incorporates the various methods described is provided. In the such an embodiment, a merchant with a collection of contents, say content-list, in his/her device to send to users of a relationship network selects one or more users from the list of users on a relationship network which is displayed on the display of his/her device. The merchant provides the device with criteria for forwarding content(s) by inputting a probability threshold between 0 and 1 along with one or more other criteria; such as age-range, specific professions, gender of users and the like; for deciding whether a content should be sent to a user or not. He/she then requests the device; by means of a click, tap or touch depending on the type of device; to forward content(s) from the content-list to users from user-list. The device calculates probability of each of the selected users to click on a content item, for each content item from the content-list, using the method to calculate probability of a click-through by a user. Then the device predicts and adds the missing profile features, which are needed to check constrains defined by the merchant, from the profiles of selected users using the method to predict profile feature. Using the profile information and the calculated probabilities, the device selects, for each content item, users to which the content should be sent, and sends the content(s) to the selected users. After the content is sent to the users, for each user to whom a content item is sent successfully, the content referral process is initiated on the user's device, as described in the method for content referral on a relationship network.

Advantages of embodiments of the invention include:

Contents with a high probability of being clicked are shared with the user, thereby serving more relevant contents. On the other hand content targeting becomes more accurate as a result of the referral process for the reason that associates of a user within a relationship network have better knowledge about the user's interests and needs, thus referring him/her right and relevant content. This enhances the user's experience and helps the merchant target a more receptive audience.

Another Advantage of the invention is automatic completion of users' relationship network profiles by prediction of missing profile features. Profiles of members of a relationship Network are crucial in leveraging its use. The profile completion is advantageous in the sense that predicted information can be used for introducing a member to other members with similar interests who are not already connected to him/her.

### BRIEF DESCRIPTION OF THE DRAWINGS

In the following, embodiments of the present invention will be described as non-limiting examples with reference to the accompanying drawings in which:

FIG. 1 shows a block diagram showing a data processing system according to an embodiment of the present invention;

FIG. 2 is a flowchart illustrating a method of providing content to users of a relationship network according to an embodiment of the present invention;

FIG. 3 illustrates an example of a relationship network considered as a graph in an embodiment of the present invention;

FIG. 4 is a flowchart showing a method of predicting missing profile features of users of a relationship network according to an embodiment of the present invention;

FIG. 5 shows an example of predicting missing profile features of users of a relationship network in an embodiment of the present invention;

FIGS. 6A and 6B illustrate an example of calculating the probability that a user will interact with a content item in an embodiment of the present invention; and

FIG. 7 shows a method of referring contents between users of a relationship network according to an embodiment of the present invention.

### DETAILED DESCRIPTION

In the following description, the term “relationship network” refers to a web-based network of a group of at least two users where the users are related/connected to each other with a relation; for example a social network where users are related with the relation friendship, a commercial network where users are related with a relation like vendor-customer relationship, employee-employer relationship, business partnership, writer-publisher relationship and the like.

In the following description, the terms “user”, “person”, and “node” will be used interchangeably, and represent a member of a relationship network; a node being the representation of a user in the Graph theoretical context.

In the following description, the terms “connected”, “linked”, and “related”, in the context of relationship network, will be used interchangeably and represent relationship between two users from a relationship network.

### A. Environment and Architecture

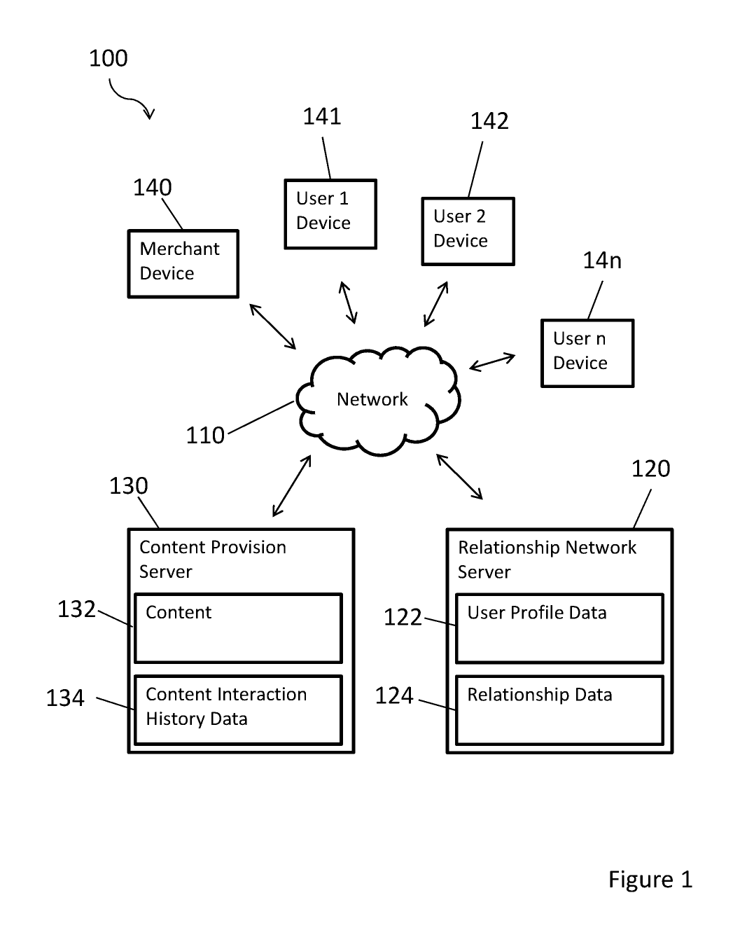

FIG. 1 is a block diagram illustrating a data processing system according to an embodiment of the present invention. The data processing system 100 comprises a network 110 which may be, for example, the internet and may be implemented as one or more local area networks (LANs) and/or wide area networks (WANs). The data processing system 100 comprises a relationship network server 120, a content provision server 130, a merchant device 140, a first user device 141, a second user device 142, and an nth user device 14n. The merchant device 140 and the user devices 141-14n may be computers, tablet devices and/or smart phone devices.

The network 110 enables communication between the relationship network server 120 and the content provision server 130 as well as between the servers and the merchant device 140 and the user devices 141-14n.

As shown in FIG. 1, the relationship network server 120 stores relationship network data which comprises user profile data 122 and relationship data 124. The user profile data 122 comprises profile information of all the users of the relationship network and the relationship data 124 comprises details of links between users of the relationship network. The relationship network server generates one or more web-pages which are used to display stored data when requested. The content provision server 130 stores information about content 132 which can be shared with the users and content interaction history 134. Content provision server also contains one or more web-pages to display the data on request. The content interaction history 134 includes information about previously shared content to each user and information about user's reaction to the shared content i.e. information like, content referral strength or user, whether user clicked/viewed the content, whether he/she referred the content to other users.

All the users (User 1, User 2 . . . User n) are members of the relationship network and each user can view profiles and news feeds of other users who have allowed him/her to access their profiles. Whenever a user views his/her own or another user's profile or news feed, the relationship network server 120 provides the data requested by the user on to the user's device to be displayed display. The content provision server 130 interacts with the merchant device 140 and provides data to the merchant device 140 for display when the merchant requests it.

The merchant may not be a member of the relationship network and hence he/she may not have access to relationship network data which is stored on the relationship network server 120. Even if the merchant is a member of relationship network, still he/she may not have access to all users' profile information 122 and relationship data 124. He/she may gather relationship network data by requesting for it from the administrator of the relationship network. He/she may then store the relationship network data on a local memory which may be accessed by merchant only. Local memory may be memory of his/her device 140, an external memory unit like a pen-drive, a memory card, a hard disk and the like, but not limited to these. On the other hand, the content provision server 130 serves all the devices including the merchant device 140 and the devices of all the users of relationship network.

When methods according to embodiments of the present invention are implemented, the merchant device 140 displays a web-page containing one or more content items which the merchant can provide to the users of the relationship network. The merchant uses the relationship network data which he/she can access from the local memory which contains the relationship network data. In some embodiments, the merchant device uses relationship network data to complete profiles of users which have some features missing. The merchant device then calculates the probabilities of click-through using the content interaction history which he/she can access from content provision server. Finally the merchant sets content forwarding criteria and request his/her device to forward the content to the users accordingly. The device analyses the users' profiles and probabilities to check whether a user-content pair meets with the merchant's criteria or not. After the content are sent to the users of the relationship network, if a content is viewed by a user, content provision server receives an indication and displays a web-page containing referral procedure on the said user's device's display.

The relationship network server 120 and the content provision server 130 may be implemented as separate servers or may be implemented on the same device. The relationship network server 120 and the content provision server 130 comprise a central processing unit (processor), a memory for storing instructions, and a network interface unit connected via a bus. The network interface unit includes the necessary circuitry for connecting the relationship network server 120 and/or the content provision server 130 to the network 110, and is constructed for use with various communication protocols including the TCP/IP and UDP/IP protocols.

A memory unit, for example a non-volatile storage such as a hard disk of the relationship network server 120 holds all relationship network data including user profile data 122 of all users and relationship data 124 comprising a list of linked users to each user on the relationship network. The user profile data 122 of a user may comprise information about the user such as age, gender, profession, hobbies, interests and the like.

In addition to the relationship network data, the memory unit of the relationship network server 120 contains one or more web pages which displays relationship network profile of a user on a device and which are communicated to the user on his/her device using the network 110 whenever a user wants to view or modify his/her relationship network profile.

The client devices such as the merchant device 140 and the user devices 141-14n each include a computer-readable medium, such as random access memory, coupled to a processor. The processor executes program instructions stored in the memory. The client devices may also include a number of Additional external or internal devices, such as, without limitation, a mouse, a CD-ROM, a keyboard, and a display. Thus, as will be appreciated by those skilled in the art, the client devices may be personal computers, personal digital assistances, mobile phones, content/media players, etc.

Through the client device a requestor such as the merchant or a user can communicate over network 110 with each other and with other systems and devices coupled to network 110, such as the content provision server 130 and the relationship network server 120.

Similar to the client devices the server devices also include a processor coupled to a computer readable memory. The processors of the client devices and the server devices can be any of a number of well-known microprocessors. In general, the client device may be any type of computing platform connected to a network and that interacts with application programs, such as a digital assistant or a “smart” cellular telephone or pager. The server devices may, although depicted as a single computer system, be implemented as a network of computer processors.

The memory of the client and/or server devices contains a number of programs, such as the components described in more detail below.

### B. Method of Providing Content to Users of a Relationship Network

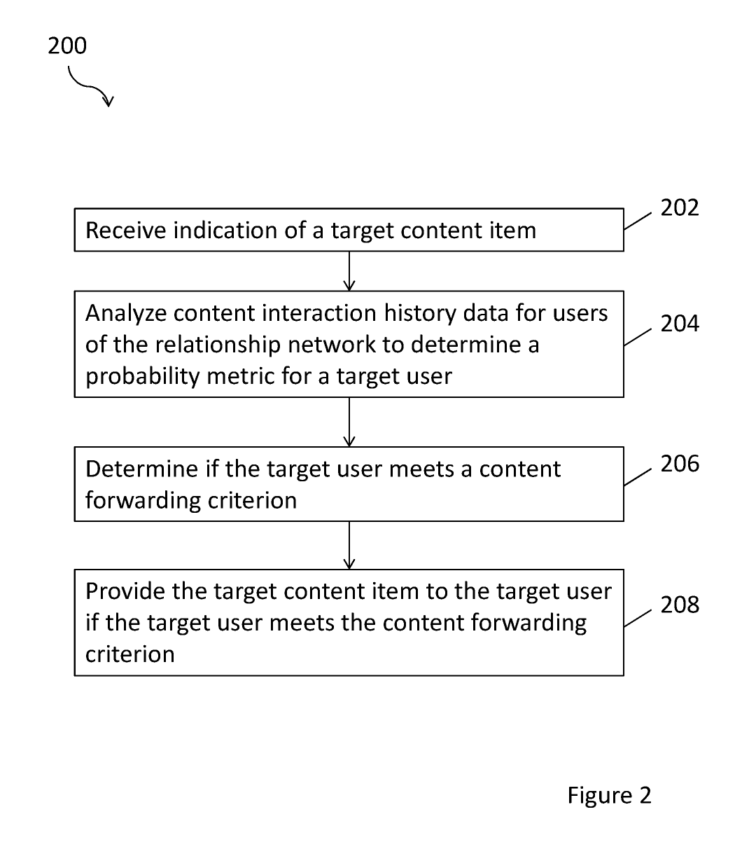

FIG. 2 is a flowchart showing a method of providing content to users of a relationship network according to an embodiment of the present invention.

The method 200 shown in FIG. 2 may be implemented on the merchant device 140 or the content provision server 130 shown in FIG. 1.

In step 202, an indication of a target content item is received. An indication of the target content item may be input into the merchant device 140. The target content item may be part of the content 132 stored on the content provision server 130.

In step 204, the content interaction history data 134 for the target content item is analyzed to determine a probability metric for the target user. The probability metric indicates a probability that the target user will click on or interact with the target content if the target content is sent to the target user.

In step 206 it is determined whether the target user meets a forwarding criterion. The forwarding criterion may be based upon the probability metric calculated in step 204. The forwarding criterion may additionally be based on other factors such as profile attributes of the target user. In some embodiments, these profile attributes are estimated from the profile attributes of other users of the relationship network.

In step 208, the target content is provided to the target user if the target user meets the forwarding criterion. Step 208 may involve the content provision server 130 sending the target content to the target user over the network 110.

### C. Method to Predict Missing Profile Feature(s) of a Member of a Relationship Network Using Profile Information of Other Users in the Relationship Network

Present approach to determine user profile features looks at the structure of interconnectivity amongst members in the relationship network. The structure of interconnectivity can be stored on a database, for example on the merchant device or on one of the relationship network server 120 and the content provision server 130 in the form of a matrix, where element [i, j], i.e. element in i^{th} row and j^{th} column of the matrix, in the matrix indicates the presence of a connection between member j and member i.

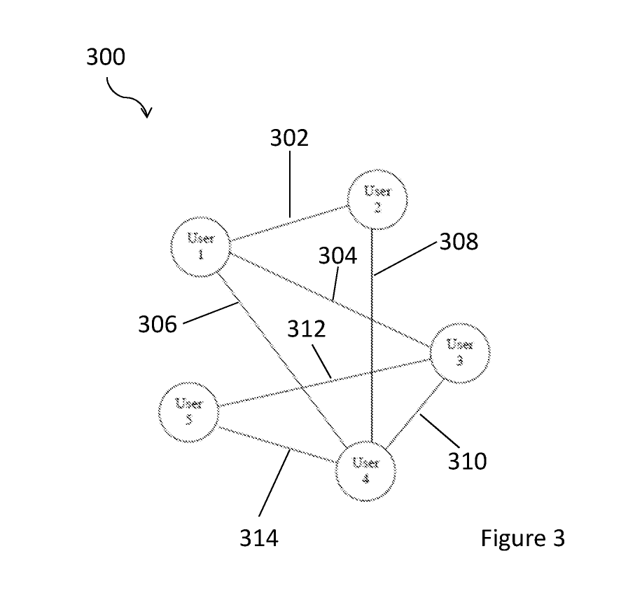

An example of a connectivity matrix used to describe the interconnectivity among relationship network users, as used in an embodiment of the present invention, is now described with reference to FIG. 3. The universe of relationship network 300 users in the example of FIG. 3 consists of only five relationship network users, for illustrative purposes. User 1 has a linkage 302 to user 2, a linkage 304 to user 3 and a linkage 306 to user 4. User 2 has a linkage 302 to user 1 and a linkage 308 to user 4. User 3 has a linkage 304 to user 1, a linkage 310 to user 4 and a linkage 312 to user 5. User 4 has a linkage 306 to user 1, a linkage 308 to user 2, a linkage 310 to user 3 and a linkage 314 to user 5. User 5 has a linkage 312 to user 3 and a linkage 314 to user 4. In the example, this interconnectivity is described by the matrix M:

$$[ \begin{matrix}0 & 1 & 1 & 1 & 0 \\ 1 & 0 & 0 & 1 & 0 \\ 1 & 0 & 0 & 1 & 1 \\ 1 & 1 & 1 & 0 & 1 \\ 0 & 0 & 1 & 1 & 0\end{matrix} ]$$

Thus, the relationship network 300 can be represented by a graph G, where each node of graph G corresponds to a member of the relationship network. If user-1 and user-2, who are members of the relationship network, are linked to each other, there is an arc between nodes representing user-1 and user-2 respectively. On the other hand, if two users are not linked to each other, then there is no arc between nodes representing them. In interconnectivity matrix M, also known as Adjacency matrix of graph G, element [i, j] is denoted by Mᵢⱼ. Mᵢⱼ is equal to 1 if there is an arc between node i and node j, otherwise Mᵢⱼ is equal to 0.

When we divide all the elements of i^{th} row the matrix M by sum of elements in the i^{th} row, we get a normalized Adjacency matrix P. Thus, sum of all elements of each row of matrix P equals 1. For graph inherited from the relationship network illustrated by FIG. 3 the normalized Adjacency matrix P is

$$[ \begin{matrix}0 & 1 \text{/} 3 & 1 \text{/} 3 & 1 \text{/} 3 & 0 \\ 1 \text{/} 2 & 0 & 0 & 1 \text{/} 2 & 0 \\ 1 \text{/} 3 & 0 & 0 & 1 \text{/} 3 & 1 \text{/} 3 \\ 1 \text{/} 4 & 1 \text{/} 4 & 1 \text{/} 4 & 0 & 1 \text{/} 4 \\ 0 & 0 & 1 \text{/} 2 & 1 \text{/} 2 & 0\end{matrix} ]$$

In the following a method to predict the profile features of a given user X, using information gathered from the linkage structure of the relationship network graph G, and the profile information of other users in X's relationship network is described.

The process can be understood as feature vector propagation through the graph G. The feature vector of a node is calculated using the feature vectors of the neighboring nodes, which in turn are calculated using the feature vectors of their neighbors. The following provides a mathematical realization of the procedure equivalent to the explanation described above, but provides a more direct and concise characterization of the procedure.

We number the nodes uniquely for identification. Each node j of the Graph G (representing a member of the relationship network) possesses a feature Collection comprising of the feature vectors as described further. According to one embodiment of the invention, every feature is assigned a probability distribution or a probability vector comprising the probability of the said feature taking a particular value. For example, consider the feature, gender of the node j. A possible probability vector could be (¼, ¾), indicating a probability of 0.25 of the member represented by node j being male and 0.75 of being female.

Embodiments of the present invention give a method of predicting feature values in the above probabilistic framework. According to one embodiment each component of the feature vector is predicted. The component is the probability of a feature taking the corresponding attribute. For example, if the feature can take 3 possible attributes, and all three attributes are equally likely, then the first, second, and third component of the feature vector will all be equal to ⅓. The method calculates these probability components for each unknown feature of each node.

According to one embodiment of the invention, the probability components of a node (for a feature), are each calculated from the same components of the given node's neighbors' feature vector.

For each node j, we define a feature vector x^{j} consisting of probabilities (x^{j}₁, x^{j}₂, x^{j}₃, . . . , x^{j}ₙ) where summation over the subscript yields 1. In the above example of the gender of a node j, x^{j}₁=0.25, x^{j}₂=0.75. Since the value of a component of a feature vector x¹, of a particular node, say node1, depends upon its neighbor in the graph, say node2, we define another score associated with all the nodes which determines how much they contribute to their neighboring nodes. This score associated with a node j is called the contribution statistic x^{j}. This statistic represents a measure of how much a particular neighbor of node j contributes to the value of each x^{j}ₖ. We define x^{j}ₖ as the weighted average of all x^{j}ₖ of neighboring nodes i.

Hence,

xₖ^{j}=Σ_{i∈Nbd(j)}xₖ^{j}/|Nbd(j)| (1)

Nbd(X) is set of users who are linked to user X in the relationship network. In terms of graph theory, Nbd(X) is collection of nodes, each of which has an arc connecting to node X. |Nbd(X)| is the number of arcs going out from node X i.e. number of elements in the set Nbd(X). Thus, |Nbd(X)| corresponds to the degree of the group X and may also be written as deg(X).

According to a preferred embodiment of the invention, the contribution statistic yⁱₖ of the node i depends recursively on the feature vector components xⁱₖ of all its neighbors. The contribution statistic seeks to normalize the probability distribution and match it to a preset value P. For example, the gender ratio can be predetermined to be 1:1 or as may be evident from the known profiles.

Preferred embodiment of the method predicts the probability of a node having a particular feature value that is not provided by the user represented by the node. The desired probability is represented by x^{u}ⱼ for node j. The method takes into account the nodes for which the particular feature value is provided by the user represented by the node, by assigning a probability score of 1 or 0 to xⁱ for nodes i with known feature values depending upon whether that feature value is possessed or not. For such nodes the probability is denoted by x^{k}ᵢ.

For a given feature value, if the probability scores for all the nodes in the social network are combined, we get a vector xᵢ. It can be seen that:

xᵢ=xᵢ^{u}+ᵢ^{k}

Therefore, from the above equation (1):

$${x}_{i}^{u} = \frac{1}{deg ( i )} {\sum }_{f ∈ Nbd ( i )} {y}_{j}$$

$${x}_{i}^{u} = {\sum }_{j = 1}^{n} {M}_{ij} . {y}_{j}$$

In Vector form this is equivalent to

x^{u}=My (2)

The contribution statistic seeks to normalize the distribution of the particular feature value according to a predetermined distribution p. Therefore,

$${y}_{i} + {\sum }_{j = 1}^{n} {A}_{ij} . {x}_{j} = {pd}_{i}$$

Where dᵢ represents the number of linkages connected to node i. Which is equivalent to:

$${y}_{i} + {\sum }_{j = 1}^{n} {A}_{ij} . {x}_{j}^{u} + {\sum }_{j = 1}^{n} {A}_{ij} . {x}_{j}^{k} = {pd}_{i}$$

In Vector form this is equivalent to:

y+Ax^{u}+Ax^{k}=pd

Therefore using (2):

(AM+I)y=pd−Ax^{k} (3.1)

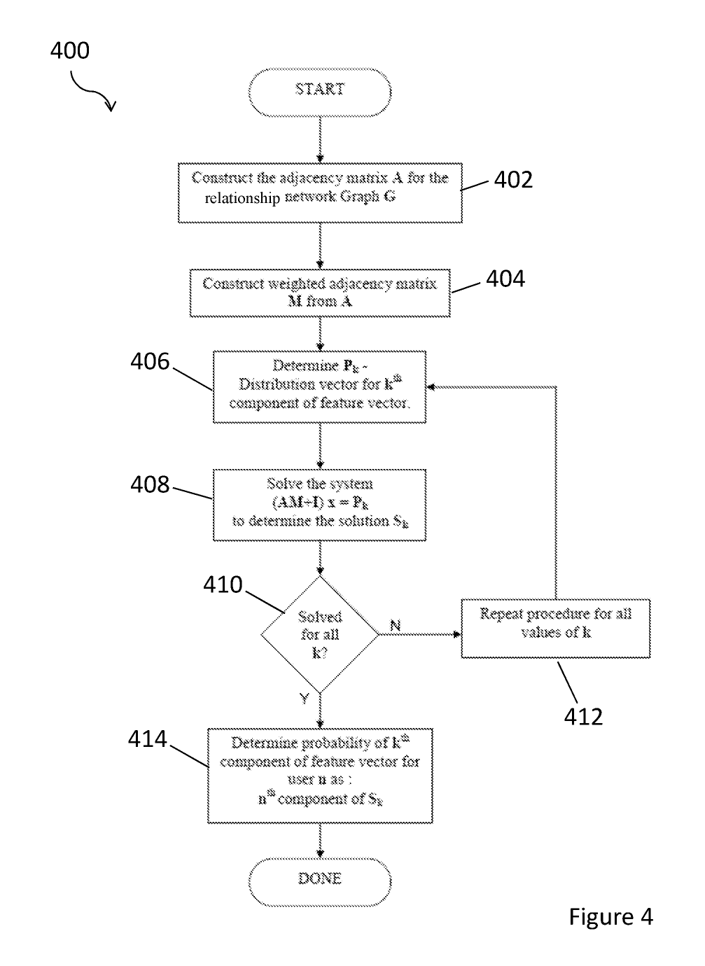

A Gaussian Reduction algorithm can be used to solve 3.1 efficiently. We call the solution S. In accordance with a preferred embodiment of the present invention, the solution S is coupled with the actual profile data, i.e. from the profiles where the feature values are known for sure and need not be predicted. The known data about a particular feature vector component can be represented in the form of a vector vₖ, having N components, one for each user. Thus in the previously mentioned example of the gender feature vector, if it is known that user 1, user3, user4 and user6 are males, and there are N=8 users in the entire social network, then v₂¹=1, v₂³=1, v₂⁴=1, v₂⁶=1. Thus the vector v₂ is (1, 0, 1, 1, 0, 1, 0, 0). In order to couple the information contained in vₖ with the solution S, various strategies might be used. A preferred strategy is that of computing the solution of 3.1 iteratively starting with initial values as given. FIG. 4 elucidates the Method presented with a flowchart.

FIG. 4 is a flowchart showing a method of predicting missing profile features of users of a relationship network according to an embodiment of the present invention.

The method 400 shown in FIG. 4 may be implemented on the relationship network server 120 or the merchant device 140 shown in FIG. 1.

In step 402 the adjacency matrix A is constructed for the relationship network graph G. In step 404, a weighted adjacency matrix M is constructed from the adjacency matrix A.

In step 406, the probability distribution vector Pₖ is determined for the k^{th} component of the feature vector. In step 408, the system (AM+I)x=Pₖ is solved to determine the solution Sₖ.

In step 410 it is checked whether the solution has been solved for all values of k. If the solution has not be solved for all values of k, the method moves to step 410 and the procedure is repeated for all values of k and the method returns to step 406.

If the solution has been solved for all values of k, the method moves to step 414. In step 414, the probability of the k^{th} component of the feature vector is determined for user n as the n^{th} component of Sₖ.

The feature probability vector could be used for searching for users within the social network with a given user profile. This could help in making new contacts and strengthening the social network.

The feature probability vector could also be used for targeted content sharing in a social network. For example, if a user has a gender feature vector as (¼, ¾), he/she would be presented with contents relevant to females and males with the same probabilities.

### D. An Example of Predicting Missing Profile Feature(s)

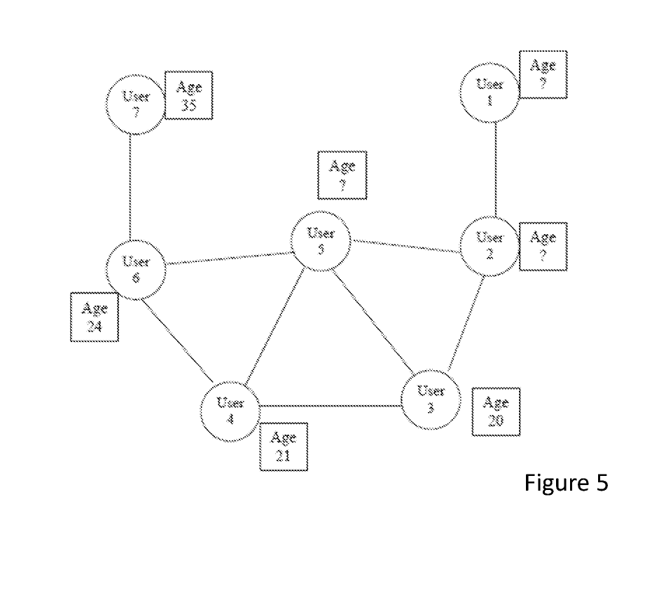

An exemplary embodiment is explained herein for the purpose of elucidation. We shall determine the various probabilities of falling in various age groups for users shown in FIG. 5. The age groups are 10-14, 15-18, 19-22, 23-27, 28-35, and 36-45. For sake of the example it is assumed that all users fall in these age groups only and there are no users of age less than 10 or more than 45. Further, ages of users 3, 4, 6, and 7 are known and are 20, 21, 24, and 35. For each user, a 6-dimensional feature probability vector is defined according to the probability of that user's age falling in the six age groups defined above. We assign indices to the 6 age groups as 1 for 10-14, 2 for 15-8, 3 for 19-22, 4 for 23-27, 5 for 28-35, and 6 for 36-45. If x² denotes the age probability vector for user 2, then x²₁=the probability of User2's age being in the first group, x²₂=the probability of User2's age being in the second group, x²₁=the probability of User2's age being in the ith group, and so on. From the figure we can see that the age of user 5 depends on the ages of users 2, 3, 5, and 6 that are connected to him. The Adjacency Matrix A for this example is

$$[ \begin{matrix}0 & 1 & 0 & 0 & 0 & 0 & 0 \\ 1 & 0 & 1 & 0 & 1 & 0 & 0 \\ 0 & 1 & 0 & 1 & 1 & 0 & 0 \\ 0 & 0 & 1 & 0 & 1 & 1 & 0 \\ 0 & 1 & 1 & 1 & 0 & 1 & 0 \\ 0 & 0 & 0 & 1 & 1 & 0 & 1 \\ 0 & 0 & 0 & 0 & 0 & 1 & 0\end{matrix} ]$$

Matrix M is calculated as

$$[ \begin{matrix}0 & 1 & 0 & 0 & 0 & 0 & 0 \\ 1 \text{/} 3 & 0 & 1 \text{/} 3 & 0 & 1 \text{/} 3 & 0 & 0 \\ 0 & 1 \text{/} 3 & 0 & 1 \text{/} 3 & 1 \text{/} 3 & 0 & 0 \\ 0 & 0 & 1 \text{/} 3 & 0 & 1 \text{/} 3 & 1 \text{/} 3 & 0 \\ 0 & 1 \text{/} 4 & 1 \text{/} 4 & 1 \text{/} 4 & 0 & 1 \text{/} 4 & 0 \\ 0 & 0 & 0 & 1 \text{/} 3 & 1 \text{/} 3 & 0 & 1 \text{/} 3 \\ 0 & 0 & 0 & 0 & 0 & 1 & 0\end{matrix} ]$$

We find the solution:

Sₖ=(AM+I)⁻¹Pₖ,

where

Pₖ=pd−Ax^{k}

is the known distribution for age group k. The solution S₁=(0.05, 0.04, 0.02, 0.05, 0.03, 0.04, 0.06) lists the probabilities of various Users age being in age group 1, hence there is a probability of 0.04 for user 2 to be in the age group1. Sₖ lists the probabilities of various Users age being in age group k. Evaluating S₂, S₃, S₄, S₅, S₆, S₇ reveals to us that it is most probable that user 2's age group is 3, user 5's—4, and user 1's—3.

### E. Graph Theoretic Method for Evaluating Relevance of a Given Content with a Given User by Evaluating Probability the Content to be Clicked by Said User

The description which follows, and the embodiments described therein, is provided by way of illustration of an example, or examples, of particular embodiments of the principles of the present invention. These examples are provided for the purposes of explanation, and not limitation, of those principles of the invention.

Although the presented embodiment contains many specifics for elucidation of the principles, anyone with skill in the art will appreciate the fact that various alterations are possible and come within the scope of the invention.

A relationship network can be represented as shown in FIG. 3, where each node corresponds to a member of the relationship network. FIG. 3 shows an example of a relationship network represented by a Graph.

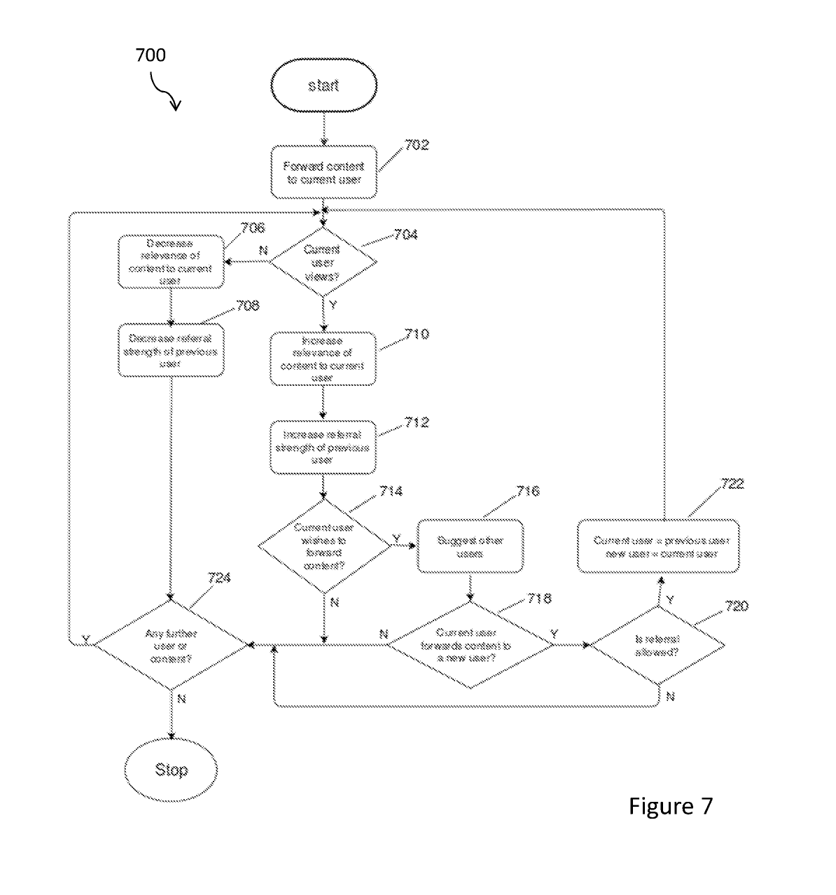

Referring to FIG. 7 which is described in more detail below, the embodiment described is a preferred method to calculate the probability that a given user X will click on a given content A.

The said probability can be influenced by the following factors:

1. The first factor is the probability of transition from a previous content to the current one (as empirically observed from the clicking behavior of the said user and other users). For example, given that a user last clicked on a content item for Brand 1 of toothpaste, it will be very probable that he/she will click on a content item for Brand2 of toothpaste. It is important here to note how it would be possible to decide whether two such brands have such a feature in common (both of them being popular brands of toothpaste). The answer lies in the behavior of all members of the relationship network. If many users click Content-2 after they click Content-1, it is highly probable that the two contents are related as in the preceding example. This is how such information about common features between two contents can be indirectly found from user behavior.

2. The second factor is the correlation of a user with the other users. Suppose user1 and user2 be two of the users from a relationship network. This correlation in terms of content-clicking behavior can be found by calculating the ratio of the number of contents that user1 and user2 both clicked, to the number of contents that user1 or user2 individually clicked. This factor takes into consideration the fact that although a large number of users may have clicked two contents in sequence, thereby increasing the probability of transition mentioned in the first factor, yet it does not necessarily translate into a similar probability of transition for the given user; as the said large number of users may have a behavior totally unrelated to the given user.

For example, user-1 has clicked on Content-1 earlier, and there are about 100 users who have clicked Content-1 followed by Content-2, but Content-1 is the only content they have clicked that is common with the contents that user-1 has clicked. If one considers only the first factor, the probability of user-1 clicking on Content-2 would increase. But since the 100 users are not correlated to user-1 in that they do not have a large number of clicked contents in common, their influence on the said probability should decrease. Therefore we take into consideration a factor of correlation between two users. For example, if user-2 and user-3 have a lot of contents they have clicked in common; user-3 will influence user-2's probability of transition from a previously clicked content to the current one more than other users.

3. The third factor we take into consideration is the nearness of other users to the said user in the relationship network. Continuing with the previous example, we can see that user-3 should influence user-2's decision of clicking the content more if he is an associate of user-2 rather than if he was associate of an associate of user-2.

Said probabilities are calculated by accessing the clicking database D, which consists of lists of contents clicked by each user of the relationship network and which is stored in merchant's device's memory.

Step 1. From the clicking database which corresponds to the content interaction history data 134 shown in FIG. 1, find the content that person X clicked last and call this content B.

Step 2.1. Prepare a list of people who clicked on content A and call it L_{A}.

Step 2.2. For each person x∈L_{A}, from the social network graph G, find the Shortest distance between x and X, call it dₓ.

Step 2.3. For each person x∈ L_{A}, from the social network graph G, find the shortest path between x and X, let its length be denoted by λ. Let M denote the Adjacency-matrix of the graph G. Compute M_{λ} and let n_{λ} denote its (i,j)^{th} entry, where x is the i^{th} node and X is the j^{th} node in the Adjacency matrix M. Here n denotes number of paths of length λ.

Similarly find n_{λ+1} and n_{λ+2} from M_{λ+1} and M_{λ+2}.

Compute:

$${S}_{x} = \frac{1}{λ} [ {Σ}_{k = 0}^{2} \frac{1}{λ + k} * {n}_{λ + k} ]$$

Here Sₓ is a metric denoting the strength of linkage between x and X.

Step 3. From the Clicking-database calculate

$${P}_{BA} = \frac{Number of times content A is clicked after content B}{Number of times content B is clicked}$$

Step 4. For each person x∈LA, find

$${P}_{x , X} = \frac{Number of contents that x and X both clicked}{Number of contents that x clicked or X clicked}$$

The desired relevance-score:

$${R}_{XA} = \frac{1}{\vert {L}_{A} \vert} [ {Σ}_{x ∈ {L}_{A}} {P}_{x , X} * ω ( {d}_{x} , {S}_{x} ) ] * {P}_{BA}$$

Where ω(dₓ, Sₓ) is a weight function depending on distance of x from X, and strength of linkage between x and X.

### F. An Example of Calculating the Probability that a Content Item Will be Clicked by a User

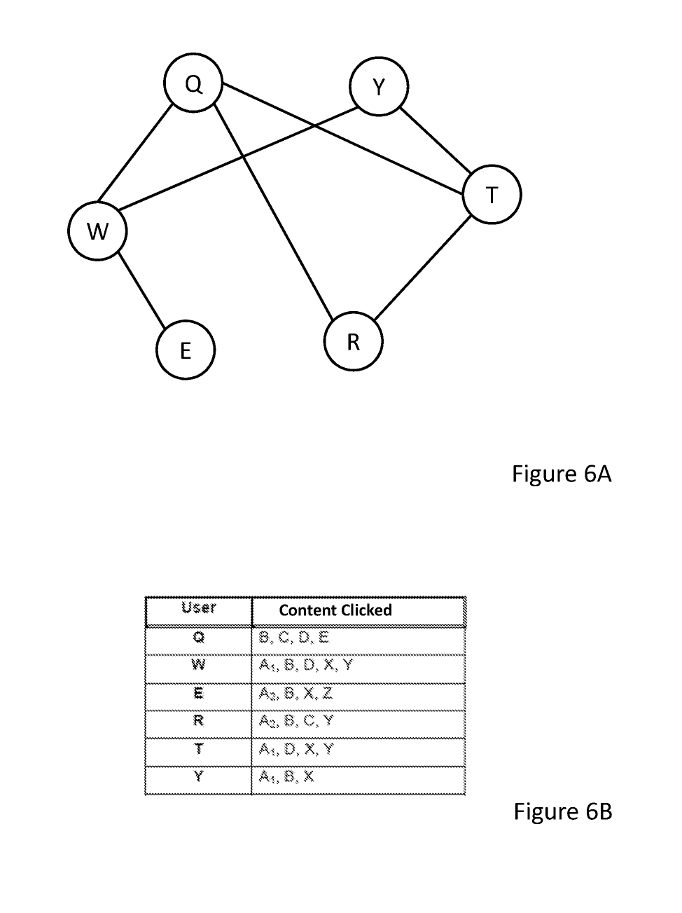

In order to illustrate the present method of calculating the desired probability, consider the simple example as shown in FIGS. 6A and 6B.

FIG. 6A shows the links between the users Q, W, E, R, T and Y. FIG. 6B shows the content clicked by the users.

The Adjacency matrix is:

$$M = [ \begin{matrix}0 & 1 & 0 & 1 & 1 & 0 \\ 1 & 0 & 1 & 0 & 0 & 1 \\ 0 & 1 & 0 & 0 & 0 & 0 \\ 1 & 0 & 0 & 0 & 1 & 0 \\ 1 & 0 & 0 & 1 & 0 & 1 \\ 0 & 1 & 0 & 0 & 1 & 0\end{matrix} ]$$

We compute:

$${M}^{2} = [ \begin{matrix}3 & 0 & 1 & 1 & 1 & 2 \\ 0 & 3 & 0 & 1 & 2 & 0 \\ 1 & 0 & 1 & 0 & 0 & 1 \\ 1 & 1 & 0 & 2 & 1 & 1 \\ 1 & 2 & 0 & 1 & 3 & 0 \\ 2 & 0 & 1 & 1 & 0 & 2\end{matrix} ]$$

$${M}^{3} = [ \begin{matrix}2 & 6 & 0 & 4 & 6 & 1 \\ 6 & 0 & 3 & 2 & 1 & 5 \\ 0 & 3 & 0 & 1 & 2 & 0 \\ 4 & 2 & 1 & 2 & 4 & 2 \\ 6 & 1 & 2 & 4 & 2 & 5 \\ 1 & 5 & 0 & 2 & 5 & 0\end{matrix} ]$$

$${M}^{4} = [ \begin{matrix}16 & 3 & 6 & 8 & 7 & 12 \\ 3 & 14 & 0 & 7 & 13 & 1 \\ 6 & 0 & 3 & 2 & 1 & 5 \\ 8 & 7 & 2 & 8 & 8 & 6 \\ 7 & 13 & 1 & 8 & 15 & 3 \\ 12 & 1 & 5 & 6 & 3 & 10\end{matrix} ]$$

The probability that user Q will click on the content A1 and that of clicking on content A2 is sought. We are given the list of contents that have been clicked by users Q, W, E, R, T and Y. We wish to find out the probabilities of user Q to click contents A1 and A2 respectively.

L_{A1}={W,Y,T}, L_{A1}={E,R}

d_{W}=1, S_{W}=3, d_{Y}=2, S_{Y}=1, d_{T}=2, S_{T}=13/6, d_{E}=1, S_{E}=17/6, d_{R}=1, S_{R}=7/2

P_{W,Q}=2/7, P_{Y,Q}=1/6, P_{T,Q}=2/7, P_{E,Q}=2/7, P_{R,Q}=2/6

P_{BA1}=3/5

P_{BA2}=2/5

P_{QA1}=1/3[2/7*3+1/6*1+2/7*13/6]*3/5=0.328571424

P_{QA2}=1/2[2/7*17/6+2/6*7/2]*2/5=0.395238095

We see how E and R contribute more to content A2's relevance-score than W, Y, and T to content A1's relevance-score. This is because E and R, are more strongly linked to Q than W, T and Y, and thus their weight function ω(dₓ, Sₓ) yields higher values.

Various implementations of the method have the Advantage that the calculation is very fast. For example data correlating existing pairs of contents and existing pairs of users can be stored in Advance and a lookup procedure can drastically reduce the calculation time for steps 2 and 3.

### G. Method for Content Referral Between Users on a Relationship Network

FIG. 7 shows a method of referring contents between users of a relationship network according to an embodiment of the present invention. The method 700 shown in FIG. 7 may be implemented on the system 100 shown in FIG. 1.

In step 702, the beginning, a merchant device 140 sends a content item to a member of the relationship network using the content provision server 130. In step 704 it is determined whether the user clicks on the content and views the content. Depending on whether the current member clicks the content or not, the relevance of the content with the user is increased or decreased. This information is then stored in the content-user relevance database which is stored in the memory of user's device. If the user does not view the content, the method moves to step 706 and the relevance of the user to the ad is decreased, then the method moves to step 708 and the reference strength of the previous user is decreased. The method then moves to step 724.

If the user views the content, the method moves to step 710 where the relevance of the user to the ad is increased. The method then moves to 712 in which the reference strength of the previous user is increased.

The method then moves to step 714 where is it determined if the user wishes to forward the ad. If prompted by the current user, in step 716, a suggestion module suggests other users linked to the current user, to whom the current user may refer the content by forwarding the content. The current user then may or may not refer the content to any number of users linked to him. In step 718 the user inputs a selection of whether to forward the ad.

If the current user refers the content to another user linked to him, in step 720, a forwarding mechanism decides whether to forward the content to the other user or not, depending upon the referral strength score of the current user. If the content is allowed to be forwarded then method moves to step 722 in which the current user is designated as the previous user and the method returns to step 702. If the forwarding mechanism forwards the content to the other user, the other user becomes the current user and the process returns to the initial stage.

If the user does not forward the ad to a new user, the method moves to step 724 where it is determined whether there are any further users or ads. If there are further users the method returns to step 704. If there are no further users the method ends.

The referral strength score of a user with another user, which is also stored in the memory of user's device, is increased or decreased depending upon whether the other user who is forwarded the content by the current user accepts/clicks or rejects/ignores the content.

In one embodiment of the method, the referrer of the content may be provided with an incentive for referring relevant contents that the referee accepts. A possible criterion, for determining whether the referee has accepted the content, could be to check if the referee has clicked on the content. A possible Incentive could be to increase the ranking of the referrer in the relationship network

In one embodiment, a member say User1 of the relationship network is provided with a set of contents, directly by the merchant, by other members who have referred the contents to the said ember, or by both. The said member, User1 can now browse through the set of contents and refer some of the contents to other members of the network who are linked to him. User1 will also have the option of Adding a short reference message containing his/her comments about the content. The relevance of the contents to the referees will be decided by User1. A possible incentive, for User1 to refer relevant contents only, could be to increase his/her ranking in the relationship network, or providing him/her some redeemable reward from the merchant.

In one embodiment, a relevance determining software module implemented, for example, in the content provision server 130 could provide the user with information on whether a given content is relevant to a given user or not, and may additionally provide a measure for relevance of the content to the user. Additionally, the software may provide a list of users who have a high relevance measure with the given content. The user can be provided with an option to rate the content that he has been forwarded. The relevance determining software module can use this rating to improve relevance measurement of the content and the user.

### H. An Example of Content Referral

In order to illustrate an exemplary embodiment of the method for content referral, consider a User A, who is a member of a relationship network X. User A is presented with a list of 4 contents, C1, C2, C3 and C4. C1 and C2 are contents related to dog food, sent to User A directly by the merchants. C3 and C4 are contents related to books on computer Science and Classical Music respectively. A small icon or title-text tells User A that C1 and C2 are about dog food, which A is not interested in, as he does not have a pet dog. Therefore he does not view C1 and C2. This information may be utilized to further prevent any contents related to dog food from being referred to User A. User A is interested in both the books and clicks on both C3 and C4. He/she then refers C3 to User B, who is linked to him/her in the relationship network and who is a student of Computer Science. And User A refers C4 to User C, who is a musician. Since User A knows Users B and C well, he/she knows that the C3 and C4 would be of use to them. This is an example of how beneficial the content referral process can be in a relationship network.

### I. Exemplary Embodiment

In an exemplary embodiment a merchant selects one or more content(s) from a list of content(s), which is stored in the memory of his/her device, displayed on his/her device's display. Let's call the list of selected content(s) content-list. He/she browses through a list of users from a relationship network, which he/she has in his/her device's memory and which is fetched from the memory of relationship network, and selects one or more users from the list. Let's refer to the list of selected users as user-list. He/she provides the device with a probability threshold by inputting a number between 0 and 1 into the device for deciding whether a content item should be sent to a user or not. Finally He/she requests the device; by means of a click, tap or touch depending on the type of device; to forward content(s) from the content-list to users from user-list.

The merchant's device processes the request by implementing the steps of method to calculate the probability of a user clicking on a content item for each user and each content item from user-list and content-list respectively. To calculate said probabilities, merchant's device uses two sets of data which are stored in the memory of the device; 1) History of content(s) clicked by each user from user-list, and 2) For each user from user-list, record of users linked to that particular user on the relationship network, which is fetched from the memory of relationship network server.

The merchant's device calculates the probabilities and checks for each content-user pair if the probability of the user, from content-user pair, to click on the corresponding content is above the threshold defined by the merchant. If the said probability is above the threshold, the device forwards the content, from content-user pair, to the corresponding user. The device carries out the above steps for each content-user pair where content comes from content-list and user comes from user-list.

### J. Exemplary Embodiment

In an exemplary embodiment a merchant selects one or more content(s) from a list of content(s), which is stored in the memory of his/her device, displayed on his/her device's display. Let's call the list of selected content(s) content-list. He/she browses through a list of users from a relationship network, which he/she has in his/her device's memory and which is fetched from the memory of relationship network, and selects one or more users from the list. Let's refer to the list of selected users as user-list. He/she provides the device with a probability threshold by inputting a number between 0 and 1 into the device for deciding whether a content item should be sent to a user or not. Finally, he/she requests the device; by means of a click, tap or touch depending on the type of device; to forward content(s) from the content-list to users from user-list.

The merchant's device processes the request by implementing the steps of method to calculate the probability of a user clicking on a content item for each user and each content item from user-list and content-list respectively. To calculate said probabilities, merchant's device uses two sets of data which are stored in the memory of the device; 1) History of content(s) clicked by each user from user-list, and 2) For each user from user-list, record of users linked to that particular user on the relationship network, which is fetched from the memory of relationship network server.

The merchant's device calculates the probabilities and checks for each content-user pair if the probability of the user, from content-user pair, to click on the corresponding content is above the threshold defined by the merchant. If the said probability is above the threshold, the device forwards the content, from content-user pair, to the corresponding user. The device carries out the above steps for each content-user pair where content comes from content-list and user comes from user-list.

Once a content item is sent by the merchant's device to a user of relationship network, the said user receives the content on his/her device. The said user may or may not choose to view the content. If the user does not view the content, the method terminates. On the other hand, if the user views the content, then he/she may or may not, by clicking or tapping on a button displayed on his/her device's display, choose to refer the content to one or more of the users linked to him/her on the relationship network.

If the user does not want to refer the content to any of his links on the relationship network, the method terminates. Otherwise, the user's device displays the list of his/her links on the relationship network. The user selects a number of users from the displayed list and refers the content to selected users, by clicking/tapping on a button shown on the display of the device depending upon the type of device used by the said user.

For each user selected by the said user the device examines the referral strength-score of the said user with selected user. If the device finds the referral score to be more than a predefined threshold, the content is forwarded to the selected user by the device. Otherwise the referral request is ignored for the selected user. If the content is forwarded to one of the selected users and he/she views the content, the referral strength-score of referring user with receiving user increases by a predefined amount. For every user who receives referred content, receiving user takes place of the referring user and the referral process start from the beginning on receiving user's device. The referring keeps going on until at some stage no referrals are made by any of the users.

### K. Exemplary Embodiment

In an example embodiment a merchant selects one or more content(s) from a list of content(s), which is stored in the memory of his/her device, displayed on his/her device's display. Let's call the list of selected content(s) content-list. He/she browses through a list of users from a relationship network, which he/she has in his/her device's memory and which is fetched from the memory of relationship network, and selects one or more users from the list. Let's refer to the list of selected users as user-list. He/she provides the device with criteria for forwarding content(s) by inputting a probability threshold between 0 and 1 along with one or more other criteria; such as age-range, specific professions, gender of users and the like; for deciding whether an content should be sent to a user or not. Finally he/she requests the device; by means of a click, tap or touch depending on the type of device; to forward content(s) from the content-list to users from user-list.

In order to define criteria for sending a content item to a user the merchant needs to have a record of profile features; like age, gender, profession and the like; of the users on the relationship network. However, some of the users' networking profiles may not be complete. So the merchant's device uses the profile information, which is collected from the relationship network server and is stored in the memory of the device, to predict and add missing profile information of the users from user-list.

Then the merchant's device implements the steps of method to calculate the probability of a user clicking on a content item for each user and each content from user-list and content-list respectively. To calculate said probabilities, merchant's device uses two sets of data which are stored in the memory of the device; 1) History of content(s) clicked by each user from user-list, and 2) For each user from user-list, record of users linked to that particular user on the relationship network, which is fetched from the memory of relationship network server.

The merchant's device checks for each content-user pair whether the probability value corresponding to a content-user pair is above the probability threshold defined by the merchant and whether the said content-user pair meets with other criteria defined by the merchant. If the pair clears all the criteria checks, the device forwards the content, from content-user pair, to the corresponding user. The device carries out the above steps for each content-user pair where content comes from content-list and user comes from user-list.

### L. Preferred Embodiment

In an example embodiment, a merchant selects one or more content(s) from a list of content(s), which is stored in the memory of his/her device, displayed on his/her device's display. Let's call the list of selected Content(s) content-list. He/she browses through a list of users from a relationship network, which he/she has in his/her device's memory and which is fetched from the memory of relationship network, and selects one or more users from the list. Let's refer to the list of selected users as user-list. He/she provides the device with criteria for forwarding content(s) by inputting a probability threshold between 0 and 1 along with one or more other criteria; such as age-range, specific professions, gender of users and the like; for deciding whether an content should be sent to a user or not. Finally he/she requests the device; by means of a click, tap or touch depending on the type of device; to forward content(s) from the content-list to users from user-list.

In order to define criteria for sending a content item to a user the merchant needs to have a record of profile features; like age, gender, profession and the like; of the users on the relationship network. However, some of the users' networking profiles may not be complete. So the merchant's device uses the profile information, which is collected from the relationship network server and is stored in the memory of the device, to predict and add missing profile information of the users from user-list.

Then the merchant's device implements the steps of method to calculate the probability of a user clicking on a content item for each user and each content from user-list and content-list respectively. To calculate said probabilities, merchant's device uses two sets of data which are stored in the memory of the device; 1) History of content(s) clicked by each user from user-list, and 2) For each user from user-list, record of users linked to that particular user on the relationship network, which is fetched from the memory of relationship network server.

The merchant's device checks for each content-user pair whether the probability value corresponding to a content-user pair is above the probability threshold defined by the merchant and whether the said content-user pair meets with other criteria defined by the merchant. If the pair clears all the criteria checks, the device forwards the content, from content-user pair, to the corresponding user. The device carries out the above steps for each content-user pair where content comes from content-list and user comes from user-list.

Once a content item is sent by the merchant's device to a user of relationship network, the said user receives the content on his/her device. The said user may or may not choose to view the content. If the user does not view the content, the method terminates. On the other hand, if the user views the content, then he/she may or may not, by clicking or tapping on a button displayed on his/her device's display, choose to refer the content to one or more of the users linked to him/her on the relationship network.

If the user does not want to refer the content to any of his links on the relationship network, the method terminates. Otherwise, the user's device displays the list of his/her links on the relationship network. The user selects a number of users from the displayed list and refers the content to selected users, by clicking/tapping on a button shown on the display of the device depending upon the type of device used by the said user.

For each user selected by the said user the device examines the referral strength-score of the said user with selected user. If the device finds the referral score to be more than a predefined threshold, the content is forwarded to the selected user by the device. Otherwise the referral request is ignored for the selected user. If the content is forwarded to one of the selected users and he/she views the content, the referral strength-score of referring user with receiving user increases by a predefined amount. For every user who receives referred content, receiving user takes place of the referring user and the referral process start from the beginning on receiving user's device. The referring keeps going on until at some stage no referrals are made by any of the users.

### M. Conclusion

Information mined from a relationship network is of great use in determining key features like the demography, interests, income-group, etc. of the user. The strength of embodiments of the present invention lies in the use of graph topology inherent in the relationship network. Content with a high probability of being clicked are shown to the user, thereby serving more relevant contents. This enhances the user's experience and helps the merchants target a more receptive audience.

Moreover, prediction of missing profile features and completion of one's relationship network profile is beneficial for member of a relationship network for a complete user profile helps other users to know more about the user which makes it easier for them to decide if it will be in their interest to get into a relationship with the user.

Whilst the foregoing description has described exemplary embodiments, it will be understood by those skilled in the art that many variations of the embodiment can be made within the scope and spirit of the present invention.

1. A method of providing content to users of a relationship network, the method comprising:
receiving an indication of a target content item;
analyzing content interaction history data for users of the relationship network to determine a probability metric for a target user of the relationship network, the content interaction history data indicating, for each user of a plurality of users of the relationship network, content items with which that user interacted, the probability metric indicating a probability that the target user will access the target content item;
determining a predicted value for a profile feature of the target user by analyzing relationship data indicating relationships between users of the relationship network and user profile data indicating values of the profile feature for users of the relationship network;
determining if the target user meets a content forwarding criterion, the content forwarding criterion comprising a threshold for the probability metric and a profile feature or range of values for a profile feature of the target user; and
providing the target content item to the target user if the target user meets the content forwarding criterion.

2. The method according to claim 1, wherein analyzing content interaction history for users of the relationship network to determine a probability metric for a target user of the relationship network comprises analyzing the content interaction history of users having a link in the relationship network to the target user.

3. The method according to claim 1, wherein analyzing content interaction history for users of the relationship network to determine a probability metric for a target user of the relationship network comprises identifying related content with which the target user interacted; identifying users that interacted with the related content; and identifying which of the users that interacted with the related content also interacted with the target content.

4-6. (canceled)

7. The method according to claim 1, further comprising representing the relationship network as a graph having a plurality of nodes, with each node corresponding to a user of the relationship network and the graph having arcs between pairs of nodes corresponding to linked users of the relationship network and considering each node as having a plurality of feature values corresponding to the profile features of the user corresponding to the node and assigning a probability distribution or probability vector to the feature values, the probability distribution or probability vector indicating the probability that the feature values will take a value.

8. The method according to claim 1, further comprising, after providing the target content to the target users, receiving a referral indication from the target user, the referral indication indicating a user, suggested to receive the target content.

9. The method according to claim 8, further comprising comparing a referral strength score associated with the target user with a threshold and providing the target content to the suggested user if the referral strength score is greater than the threshold.

10. The method according to claim 9, further comprising determining if the suggested user interacts with the target content and increasing the referral strength score associated with the target user if the suggested user interacts with the target content.

11. A method of providing content to users of a relationship network, the method comprising:
receiving an indication of a target content item;
determining a predicted value for a profile feature of a target user of the relationship network by analyzing relationship data indicating relationships between users of the relationship network and user profile data indicating values of the profile feature for users of the relationship network;
determining if the target user meets a content forwarding criterion, the content forwarding criterion comprising the profile feature or range of values for the profile feature of the target user; and
providing the target content item to the target user if the target user meets the content forwarding criterion.

12. The method according to claim 11, further comprising representing the relationship network as a graph having a plurality of nodes, with each node corresponding to a user of the relationship network and the graph having arcs between pairs of nodes corresponding to linked users of the relationship network.

13. (canceled)

14. A method of providing content to users of a relationship network, the method comprising:
providing a target content item to a first user of the relationship network;
receiving a referral indication from the first user of the relationship network, the referral indication indicating a second user suggested by the first user to receive the target content item; and
providing the target content item to the second user.

15. A method of providing content to users of a relationship network, the method comprising:
providing a target content item to a first user of the relationship network;
receiving a referral indication from the first user of the relationship network, the referral indication indicating a second user suggested by the first user to receive the target content item;
comparing a referral strength score associated with the first user with a threshold; and
providing the target content item to the second user if the referral strength score associated with the first user is greater than the threshold.

16. The method according to claim 15, further comprising determining if the second user interacts with the target content and increasing the referral strength score associated with the first user if the second user interacts with the target content.

17. The computer readable carrier medium carrying processor executable instructions which when executed on a processor cause the processor to carry out a method according to claim 1.

18. A data processing system for providing content to users of a relationship network, the system comprising a processor and a data storage device storing processor executable instructions for carrying out a method comprising:
receiving an indication of a target content item;
analyzing content interaction history data for users of the relationship network to determine a probability metric for a target user of the relationship network, the content interaction history data indicating, for each user of a plurality of users of the relationship network, content items with which that user interacted, the probability metric indicating a probability that the target user will access the target content item;
determining a predicted value for a profile feature of the target user by analyzing relationship data indicating relationships between users of the relationship network and user profile data indicating values of the profile feature for users of the relationship network;
determining if the target user meets a content forwarding criterion, the content forwarding criterion comprising a threshold for the probability metric and a profile feature or range of values for a profile feature of the target user; and
providing the target content item to the target user if the target user meets the content forwarding criterion.

19. The data processing system according to claim 18, wherein analyzing content interaction history for users of the relationship network to determine a probability metric for a target user of the relationship network comprises analyzing the content interaction history of users having a link in the relationship network to the target user.

20. The data processing system according to claim 18, wherein analyzing content interaction history for users of the relationship network to determine a probability metric for a target user of the relationship network comprises identifying related content with which the target user interacted; identifying users that interacted with the related content; and identifying which of the users that interacted with the related content also interacted with the target content.

21-23. (canceled)

24. The data processing system according to claim 18, the method further comprising representing the relationship network as a graph having a plurality of nodes, with each node corresponding to a user of the relationship network and the graph having arcs between pairs of nodes corresponding to linked users of the relationship network and considering each node as having a plurality of feature values corresponding to the profile features of the user corresponding to the node and assigning a probability distribution or probability vector to the feature values, the probability distribution or probability vector indicating the probability that the feature values will take a value.

25. The data processing system according to claim 18, the method further comprising, after providing the target content to the target users, receiving a referral indication from the target user, the referral indication indicating a user, suggested to receive the target content.

26. The data processing system according to claim 25, the method further comprising, further comprising comparing a referral strength score associated with the target user with a threshold and providing the target content to the suggested user if the referral strength score is greater than the threshold.

27. The data processing system according to claim 25, the method further comprising determining if the suggested user interacts with the target content and increasing the referral strength score associated with the target user if the suggested user interacts with the target content.

28. A data processing system for providing content to users of a relationship network, the system comprising a processor and a data storage device storing processor executable instructions for carrying out a method comprising:
receiving an indication of a target content item;
determining a predicted value for a profile feature of the target user by analyzing relationship data indicating relationships between users of the relationship network and user profile data indicating values of the profile feature for users of the relationship network;
determining if the target user meets a content forwarding criterion, the content forwarding criterion comprising the profile feature or range of values for the profile feature of the target user; and
providing the target content item to the target user if the target user meets the content forwarding criterion.

29. The data processing system according to claim 25, the method further comprising representing the relationship network as a graph having a plurality of nodes, with each node corresponding to a user of the relationship network and the graph having arcs between pairs of nodes corresponding to linked users of the relationship network and considering each node as having a plurality of feature values corresponding to the profile features of the user corresponding to the node and assigning a probability distribution or probability vector to the feature values, the probability distribution or probability vector indicating the probability that the feature values will take a value.

30-31. (canceled)

32. A data processing system for providing content to users of a relationship network, the system comprising a processor and a data storage device storing processor executable instructions for carrying out a method comprising:
providing a target content item to a first user of the relationship network;
receiving a referral indication from the first user of the relationship network, the referral indication indicating a second user suggested by the first user to receive the target content item;
comparing a referral strength score associated with the first user with a threshold; and
providing the target content item to the second user if the referral strength score associated with the first user is greater than the threshold.

33. The data processing system according to claim 32, the method further comprising determining if the second user interacts with the target content and increasing the referral strength score associated with the first user if the second user interacts with the target content.
